(19) United States
(12) Patent Application Publication
(10) Pub. No.: US 2018/0011333 A1
(43) Pub. Date: Jan. 11, 2018

(54) SMARTPHONE STEREOSCOPE

(71) Applicant: Can ANSAY, Hamburg (DE)

(72) Inventor: Can ANSAY, Hamburg (DE)

(21) Appl. No.: 15/544,454

(22) PCT Filed: Jan. 20, 2016
(86) PCT No.: PCT/EP2016/051134

§ 371 Date: Jul. 18, 2017

(30) Foreign Application Priority Data
Jan. 20, 2015 (DE) 10 2015 000 354.2

(51) Int. Cl. G02B 27/22; G02B 27/01; H04N 13/04

(52) U.S. Cl. CPC G02B 27/2257; H04N 13/044; G02B 27/0172; G02B 27/2228

(57) ABSTRACT

A smartphone stereoscope including a receptacle for holding a smartphone in a wide-image format position. The receptacle includes magnifying lenses and a partition running parallel to the long sides of the smartphone and aligned with a dividing line between two stereoscopic images arranged side-by-side on the smartphone screen. The partition swivels or pivots on a base between use and folded positions. A lens holder including lens holders for accommodating magnifying lenses is provided on the base along with a support bar. The bar contacts a longitudinal edge of the smartphone and is provided at an upper end of the partition and, in the use position runs transversely to the partition. A clamping means holds a smartphone when the longitudinal edge is put against the support bar. In the folded position the partition, base, support bar and lens holder lie parallel to each other in a plane, or in adjacent planes.

### TECHNICAL FIELD

The invention relates to a stereoscope for a smartphone, having a receptacle for releasably mounting and securing at least one smartphone in a widescreen position, a pair of magnifying lenses, and a partition, which extends in the direction of the narrow longitudinal sides of the smartphone and is in alignment with a dividing line between two images arranged side by side for stereoscopic viewing on the at least one smartphone screen when the smartphone is mounted in the receptacle.

### PRIOR ART

Photo Stereoscopes: Stereoscopes for viewing photos of a motif taken from different perspectives, which are arranged side by side (aka “side-by-side photos”) for viewing have been around for more than 150 years. They are generally hand-held. A side-by-side photo is taken with a special camera, which takes two slightly offset photos of a motif using two adjacently disposed lenses. The finished photo thus comprises two side by side images from slightly different perspectives. When viewed through a stereoscope, the left eye views the image taken through the left lens and the right eye views the image taken through the right lens. As a result the side-by-side photo appears in 3D. During viewing, the individual images of the side-by-side photo are separated by a dividing wall. The images are viewed through the magnifying lenses of the stereoscope, which for the respective eye are arranged at a distance from the photo equal to the focal length. An example of such an arrangement in the form of a foldable stereoscope is described in EP 700531 B1.

Such stereoscopes were popular in the 1970s, wherein the photos were printed in small size on films and could thus be viewed by holding them up to the light. In these stereoscopes, there were several images on a disc, which appeared automatically in succession at the press of a button. Examples of such devices are described in U.S. Pat. No. 2,189,285 and U.S. Pat. No. 4,726,653.

Screen Stereoscopes: Electronic stereoscopes for viewing screens (monitors) have been on the market for several years. Each eye views its own screen rather than static photos, which in particular enables the viewing of animated 3D images. These screens, are often head-mounted, generally with a wide elastic band placed horizontally around the head like ski goggles. These arrangements are also called “head mounted displays”. The contents displayed on the screens generally originate from external video signal sources, for example from a PC or Blu-ray player, which are generally connected by cables to the head mounted display.

Head mounted displays with an additional “virtual reality” feature have also been around for several years. However, the latter have only appeared on the market sporadically in the past and are just now beginning to conquer a larger market. The virtual reality arises from the fact that all head movements also change the viewing angle of the motif being observed. For example, in the case of a virtual reality motif in which the user is looking at a beach with his back to the sea and then turns his head 180° and thus looks “backwards”, he will then be looking out over the open sea. If he then looks straight up, he will see the sky, and so forth. In the virtual reality motif, the user can therefore look in all directions the way he could if he actually were in the corresponding real place. Examples of motifs include special virtual reality photos and videos in particular. However, computer-generated virtual reality environments are ideal as motifs because they appear in 3D and the user can circulate freely therein. US Design 701,206 S1 discloses such a head-mounted display for viewing a virtual reality.

In addition, stereoscopes for viewing smartphones with the side-by-side technique have been on the market for ca. two years. Unlike the head-mounted displays described in the preceding, these devices do not have their own screens and instead use the screen of a smartphone, which is fastened in front of the stereoscope. Such stereoscopes for smartphones became known to a broader public in mid-2014 through an inexpensive stereoscope with a cardboard frame, which was developed by a search engine company. This prior art stereoscope is designed for hand-held use.

Various, plastic head-mounted stereoscopes for smartphones, which as a rule are constructed similarly to ski goggles, have since become available on the market. The smartphone is mounted by means of an opaque, deep frame in front of the device, the design of which is reminiscent of ski goggles. The stereoscope itself is fastened around the back of the head by means of a wide rubber strap (similar to the fastening of ski goggles). The distance of the lenses from each other, the distance of the lenses from the smartphone, or the distance of the lenses from the eyes can be adjusted in some models. The first big companies introduced head-mounted stereoscopes for smartphones to the US market in December of 2014. In different exemplary embodiments, US 2014/0375531 A1 illustrates arrangements with which stereoscopes for smartphones can be mounted on the head of a user. In addition to a solution with a strap system having an essentially horizontal forehead strap and an upper head strap guided along the vertical sides, also illustrated is an option in which the smartphone itself is secured to a holder on the visor of a headgear item shaped similarly to a baseball cap. The lenses for viewing the two separate images are arranged on an eyeglasses frame that is worn in the manner of corrective eyeglasses and thus separately from the headgear item.

Owing to the cameras integrated in smartphones, these devices can also depict so-called “augmented reality” in conjunction with a stereoscope for smartphones, particularly if the latter can be mounted on the head. The user sees his normal, real field of vision through the camera, with virtual motifs such as virtual people or figures (e.g., monsters), or information (e.g., street names) displayed therein. An example of this is described in DE 20 2013 009 830 U1.

### Presentation of the Invention

However, the stereoscopes for smartphones known from the prior art have disadvantages and problems. They are relatively large and therefore not easily carried as mobile devices. They are relatively expensive and complicated to produce. They are only suited for certain sizes of smartphones. The distance of the lenses from each other cannot be adjusted small enough to fit children's eyes. They are often uncomfortable to wear as head-mounted devices because they concentrate contact pressure on small portions of the face and they are also relatively heavy. Owing to the enclosed construction of prior art devices, the touchpad of the smartphone cannot be used while wearing the device, the user does not see his surroundings and therefore cannot eat, operate a keyboard, etc. Plus the lenses fog up, especially after prolonged use. At least in some countries (e.g., under German law), they count as disguises and therefore may not be worn at public events such as soccer games, for example.

The underlying object of the invention is therefore that of developing a stereoscope for smartphones (henceforth simply designated as “smartphone stereoscope”), which eliminates at least one of the problems of the prior art described in the preceding.

This object is inventively achieved by the characterizing features of the smartphone stereoscope in that the device has a base, the partition is arranged on the base so that it can be pivoted between an unfolded position, in which it is in a use position of the smartphone stereoscope, and a collapsed position, in which it lies parallel to the base or in the plane of the base, a lens holder with lens receptacles for receiving magnifying lenses is also arranged on the base, provision is made of a support bar on a first, upper end of the partition, which support bar in the use position runs crosswise, in particular essentially perpendicular, to the partition for supporting a longitudinal edge of at least one smartphone, provision is made of a clamping and holding means for clamping and holding a smartphone positioned with a longitudinal edge on the support bar, and the smartphone stereoscope can be collapsed in such a way that the partition, the base, the support bar, and the lens holder lie parallel to one another in a plane or in superimposed planes.

Advantageous embodiments include that the base has the support bar integrally formed on a first side situated in the front during use, that the partition is mounted on the base so that it can pivot about an axis that is perpendicular to a longitudinal direction of the support bar, and that the lens holder with the magnifying lenses arranged thereon is arranged on the base so that it can pivot about an axis that extends parallel to the longitudinal direction of the support bar. A cutout may be provided in the base for accommodating a portion of the partition when the latter is pivoted out of the use position for collapsing. A portion of the partition, which comes into engagement with a portion of the lens holder when the lens holder and the partition are pivoted into their positions assumed in the use position. Furthermore, a latching means on the portion of the partition and on the portion of the lens holder, which come into mutual engagement in the use position and interlock the lens holder and the partition in a latching manner. The partition has a diagonally running edge line on a side oriented towards the lens holder in the use position, wherein as a result of the diagonal run, the partition tapers in its depth from the top end to a bottom end. A bridge is arranged on the side of the support bar oriented away from the lens holder and running parallel to the support bar, at a distance therefrom, in the use position. Additionally, the clamping and holding means are configured as an elastic pull strap, which extends from two fastening points spaced apart from each other in the longitudinal direction of the support bar in the zone of the support bar to a common fastening point on the partition. The common fastening point of the elastic pull strap, seen in a longitudinal direction extending from the top end to the bottom end of the partition, can be secured on the partition at different selectable longitudinal positions. Furthermore, the elastic pull strap is arranged in such a way that as the partition is pivoted into the collapsed position, it exerts a reset force thereon that forces the partition back into the unfolded position. The clamping and holding means may be formed by a partition that is spring-elastically tensioned in a compressed position and is capable of telescoping between the compressed position and an extended position. Additionally, the magnifying lenses can be adjusted with respect to their distance from each other in the lens holder. The lens receptacles are coupled with each other by means of a gear pair with meshing teeth and fix-mounted on the lens holder such that the lens receptacles pivot simultaneously and symmetrically as the distance between the lens holders is adjusted. The magnifying lenses may be Fresnel lenses. Still further, the smartphone stereoscope has means for being releasably secured on the underside of a visor of a baseball cap, of a visor cap, or of a comparable peaked cap. The means for releasably securing on the underside of the visor may be an undercut slot, which is formed in a top side of the base oriented away from the partition in the use position. A baseball cap or visor cap or comparable peaked cap having a smartphone stereoscope mounted under its visor is another aspect of the invention. This solves other problems recognized in the prior art. Advantageous refinements thereof include that the baseball cap or visor cap or comparable peaked cap may include a hood secured on the cap, which can be guided over the visor and over the smartphone stereoscope and which can be releasably fastenable on a bottom end of the partition of the smartphone stereoscope. The hood may be an elastic hood and be fastened on the cap in such a way that it can be selectively guided over the visor and over the smartphone stereoscope and releasably securable on a bottom end of the partition of the smartphone stereoscope or guided over the top of the user's head in such a way that it covers the top of the user's head. The smartphone stereoscope can be displaced on the underside of the visor between different positions of distance from the user's face. The baseball cap or visor cap or comparable peaked cap may include an inner terry cloth covering on a headband portion of the cap. Furthermore, the baseball cap or visor cap or comparable peaked cap may include two lateral tips of the visor at an angle of 20-60°, preferably 35°, to the forehead are cut to the uppermost layer so that they can be folded 180° onto a top part of a front visor part.

Owing to the foldability with the partition that is pivotally attached to the base, the smartphone stereoscope of the invention can be configured so that it is stable in the use position but at the same time compact and therefore easily transported and stored in the collapsed position. The special design also enables a minimalistic and open construction of the stereoscope, thus making it inexpensive to produce and user friendly. For example, it can be formed with the essential components made of plastic and thus easily and inexpensively manufactured. However, other materials such as wood or metal are also conceivable, wherein the magnifying lenses are obviously made out of glass or (preferably) out of a transparent plastic material.

Making the stereoscope, including the magnifying lenses, out of plastic is particularly advantageous for weight reduction reasons. A weight reduction is also achieved through the option of using Fresnel lenses as magnifying lenses. Such plastic Fresnel lenses are furthermore very inexpensive to obtain.

In principle, the smartphone stereoscope of the invention can be delivered to the user as an easy-to-assemble kit.

The support bar, which forms a component of a smartphone holder, can be used universally as a support for a longitudinal edge of all standard smartphones. The partition, as an element having a front edge oriented towards the front side of the stereoscope and extending essentially perpendicular to a longitudinal direction of the support bar in the use position, can also form a support, wherein this edge in particular can assume an angled or curved profile and thus be slightly offset diagonally in one area with respect to another area and longer than the widest smartphone available on the market, such that in all models, a lower pressure and contact point, at which the smartphone rests on the partition with an upper edge in contact with the support bar, always lies on the lower edge of the smartphone, and the smartphone does not rest on the partition in areas in-between. However, the smartphone stereoscope can also be configured such that it can accommodate not only one but also two smartphones arranged side by side in widescreen orientation. The partition then lies in an area between the displays of the two smartphones. In this use, a complete image of the side-by-side (sbs) images is shown on each of the displays of the smartphones, wherein the image on the display of the left smartphone is viewed with the left eye, the image on the display of the right smartphone is viewed with the right eye, and the 3D impression is then generated, while viewing, by the different perspectives of said images.

An especially compact foldability and, at the same time, a sturdy construction are obtained if the base has the support bar integrally formed on a first side that is forwardly positioned in use, if the partition is mounted so that it can pivot about an axis perpendicular to the longitudinal axis of the support bar, and if the lens holder with the magnifying lenses arranged thereon is arranged on the base so that it can pivot about an axis running parallel to the longitudinal axis of the support bar. Starting from the use position, the partition can thus initially be pivoted, in particular by ca. 90°, and folded down in the plane of the base and subsequently the lens holder can be pivoted, also and in particular by ca. 90°, and positioned in a compact fashion on the base and the folded partition. Provision can then be made of latching means for releasably interlocking at least the lens holder and the base. The folded position, in which the smartphone stereoscope is compact and flat and thus easily stored and transported, is thus secured. In particular the base can have a cut-out, which is shaped and configured to receive the partition in the folded down position. A stop, for example, can also be provided here to prevent the partition from over-pivoting.

In the use position, a very stable and at the same time simple structure is achieved by the three elements base, partition, and lens holder, which are in particular oriented pairwise perpendicular to one another and are essentially flat or plate-shaped. To secure and fix the smartphone stereoscope in the use position, a portion of the partition can engage with a portion of the lens holder when the lens holder and the partition are pivoted into their positions assumed in the use position. In particular, latching means can then be provided on the portion of the partition and on the portion of the lens holder, which come into engagement with each other in the use position and interlock the lens holder and the partition in a latching manner.

As a cutout for the nose or rather the bridge of a user's nose, the partition can have a diagonally running edge line on a side oriented toward the lens holder in the use position, wherein as a result of the diagonal run, the partition tapers in its depth from the top end to the bottom end. This cutout is particularly advantageous if the smartphone stereoscope is to be positioned and held in front of a viewer's face, as will be explained in more detail.

With a bridge arranged on the side of the support bar oriented away from the lens holder and running parallel to the support bar and at a distance therefrom in the use position, a U-shaped receiving channel is formed, which is delimited by the support bar and the bridge and in which a longitudinal edge of a smartphone introduced therein can be even better held.

The clamping and holding means can in particular be configured as an elastic pull strap, e.g., as a rubber strap, which runs from two fastening points spaced apart from one another in the longitudinal direction of the support bar in the area of the support bar to a common fastening point on the partition. For example, it can be fastened to the two longitudinal ends of the support bar. The elastic pull strap can be configured as a continuous band, but can also be composed of several portions, for instance two separate straps that extend from the common fastening point, to which they are each secured by an end, to one or the other fastening point in the area of the support bar. In particular, the elastic pull strap can be guided in an essentially axially symmetric or mirror-inverted manner with respect to the partition in the use position.

The common fastening point of the elastic pull strap can be fastened on the partition at different longitudinal positions, seen in a longitudinal direction running from the top end to the bottom end of the partition, in order to design the receptacle for releasably receiving and securing a smartphone in such a way that it can be adjusted with respect to the width of the smartphone.

An elastic pull strap formed as described in the preceding can in particular also be arranged in such a way that, as the partition is pivoted into the collapsed position, the strap exerts a reset force on the partition for returning the latter to the unfolded position assumed in the use position. Hence, the elastic pull strap can serve two functions: a function of holding a smartphone in the receptacle in the use position of the stereoscope and the function of a pretensioning element that forces the partition into the position assumed in the use position when the stereoscope is collapsed or folded.

In an alternative design, the clamping and holding means can also be formed by, for example, a partition that is spring-elastically tensioned in a compressed position and is capable of telescoping between the compressed position and an extended position. In such an embodiment, the partition would have a thrust bearing on a lower end opposite the support bar, which engages on a longitudinal edge disposed opposite the longitudinal edge and borne on the support bar and thus holds the smartphone.

The magnifying lenses can be set at a fixed distance to one another in the lens holder. However, the distance between the magnifying lenses in the lens holder is advantageously adjustable so that different users having different eye separation distances can use the smartphone stereoscope comfortably. Thus the lens separation distance can advantageously be reduced in such a way that the lenses or rather their holders touch at their edges. In particular, this permits the stereoscope to be adjusted to particularly small eye separation distances, such as those in children, thus enabling them as well to use the stereoscope of the invention.

In one advantageous design, the lens receptacles can be coupled with each other by means of a gear pair with meshing teeth and fix-mounted on the lens holder such that the lens receptacles pivot simultaneously and symmetrically as the distance between the lens holders is adjusted.

The smartphone stereoscope of the invention can in particular also have means for releasable fixation on the underside of a visor of a baseball cap, a visor cap, or other comparable peaked cap. A visor cap is understood to mean a headgear item with a visor, which is intended to be worn with the visor on the forehead side and which merely has a circumferential headband rather than a hood spanning the top of the head.

If the otherwise “standard” hand-held smartphone stereoscope of the invention is to be fastened by suitable means to the visor of such a cap, specifically on the underside of said visor, the stereoscope can be made into a head mounted display (if a smartphone is disposed in the receptacle and shows side-by-side images) in a very expedient manner by wearing the cap. For fastening to a visor of such a cap, provision can be made of, for example, a clip tensioned in a clamping position, which is mounted on the stereoscope. The base, particularly in an area between the forward-positioned support bar and the lens holder, can then be the underside of such a clip. With such a clip, the smartphone stereoscope can, in principle, be fastened to the visor of any cap, thus changing the cap into a head mounted display.

However, an undercut groove formed in a top side of the base oriented away from the partition in the use position can also be the means for the releasable fastening on the underside of the visor of a cap. A corresponding track or corresponding grooved blocks must then be provided on the underside of the visor of the cap. Even though it requires a specially prepared cap, this solution has the advantage that, in the use position when the track or the undercut groove extends in a direction perpendicular to the plane of the lens holder, it also gives rise to a displaceability of the stereoscope for adjusting the distance of the lens holder and thus of the magnifying lenses from the eyes of the user who is wearing the cap. This distance can thus be made sufficiently large for someone wearing corrective eyeglasses, for example, so that the corrective eyeglasses can still be worn but the stereoscope mounted on a cap in this manner can be used. Unlike prior art head mounted displays, which as has already been described, are constructed like ski goggles, the result here is an open design, which in turn gives rise to the further advantage that the magnifying lenses do not fog up due to body moisture condensing under closed goggles.

In a further aspect, the invention specifies a baseball cap or visor cap or a comparable peaked cap with a visor, on the underside of which a smartphone stereoscope as described in the preceding is fastened. In particular, the stereoscope can be releasably fastened thereon so that when it is no longer needed, for example, it can be taken off and stowed. The stereoscope can thus be safely carried and the cap can also be simply worn as such.

By mounting the smartphone stereoscope on a baseball cap or visor cap, said smartphone stereoscope is very comfortable to wear when used as a head mounted display; i.e., with a smartphone accommodated therein. This lies chiefly in the fact that such a cap, in particular a baseball cap, distributes the pressure exerted by the stereoscope with the smartphone arranged therein evenly over the head. Other advantages in particular include the availability at low cost and the general popularity of baseball caps.

Such a baseball cap or visor cap can in particular have a hood attached to the cap, which can be guided over the visor and over the stereoscope and releasably fastened to a bottom end of the partition of the smartphone stereoscope. For example, this hood can be made of a flexible and elastic material, in the manner of a bathing cap, which in particular can have a light weight per unit area for reducing the overall weight. This hood, when guided over the stereoscope (including the smartphone), results in a darkening and an elimination of scattered light, thus rendering the viewing of the stereoscopic images on the smartphone even more free of interference and impressive. A certain private sphere can also be created for the user in this manner. In the case of outdoor use, the hood can also provide protection from adverse weather effects, so that the stereoscope can also be used when it is raining, for example.

The hood can advantageously be an elastic hood, which is fastened to the cap in such a way that it can be selectively guided over the visor and over the stereoscope and releasably fastened to a lower end of the partition of the smartphone stereoscope or it can be guided over the top of the user's head in such a way that it completely covers it. By means of the hood, the cap can be held more securely on the head and a tendency of the cap to tilt forwards and downwards, which is induced by the weight of the stereoscope and in particular of the smartphone arranged on the visor, can be counteracted.

The smartphone stereoscope can in particular be moved on the underside of the visor into different positions of distance to the user's face for selectively adjusting a distance to the eyes.

On the baseball cap or visor cap, an inside terry cloth covering can advantageously be provided on a portion of the headband of the cap. This covering may not only absorb sweat on the forehead, but it also serves as an additional buffer and insulation against the pressure exerted in this area as a result of the stereoscope and smartphone arrangement fastened to the visor of the cap. The terry cloth covering can in particular be changeable and therefore replaced from time to time.

To enable the compact folding of not only the stereoscope per se but also of the cap, the visor of the latter can be cut, in particular on two lateral tips at an angle of 20-60°, preferably 35°, to the forehead up to the uppermost layer so that these lateral tips can be folded ca. 180° over a top part of a front part of the visor.

### BRIEF DESCRIPTION OF THE DRAWINGS

Other advantages and features of the invention arise from the following description of possible exemplary embodiments, with reference to the appended figures.

FIG. 1 shows a frontal view of a first design variant of a smartphone stereoscope of the invention in the unfolded state;

FIG. 2 shows a diagonal three dimensional view from front to bottom of the smartphone stereoscope of FIG. 1;

FIG. 3 shows a frontal view of the smartphone stereoscope of FIG. 1 in a state of transition between the unfolded and the collapsed state during the pivoting of the partition;

FIG. 4 shows a view from below of the smartphone stereoscope of FIG. 1, with the partition folded in but with the lens holder still unfolded;

FIG. 5 shows a view from below of the smartphone stereoscope of FIG. 1 in the fully collapsed state;

FIG. 6 shows how the smartphone stereoscope of FIG. 1 is mounted on the underside of a visor of a baseball cap;

FIG. 7 shows how the smartphone stereoscope of FIG. 1 is mounted on the underside of the visor of a baseball cap, in a diagonal three dimensional view from front to bottom;

FIG. 8 shows a smartphone stereoscope of the invention mounted on the underside of the visor of a baseball cap and with a smartphone secured therein;

FIG. 9 shows a side view of the smartphone stereoscope of the invention in an alternative design variant, mounted on the underside of a visor of a baseball cap and with a smartphone secured therein;

FIG. 10 shows a rear view of the arrangement according to FIG. 9;

FIG. 11 shows a view from below of the smartphone stereoscope according to FIG. 9, without the smartphone and in the collapsed state;

FIG. 12 shows a side view of the arrangement depicted in FIG. 11;

FIG. 13 shows a view from above of an alternative design variant of a smartphone stereoscope according to the invention equipped with a smartphone, with releasable fastening on the visor of a baseball cap;

FIG. 14 shows a side view of the design variant according to FIG. 13, with the smartphone stereoscope in the collapsed state and without a smartphone accommodated therein and

FIG. 15 depicts a hood arranged on the baseball cap, in a position in which it is guided over the smartphone stereoscope equipped with a smartphone.

Way(s) of Embodying the Invention

Exemplary embodiments (slightly differing from one another to some extent) of a smartphone stereoscope of the invention are depicted in the figures, in part in an arrangement on the underside of a baseball cap visor. The illustrations shown are not in any way high precision design drawings, but rather schematic sketches depicting the essential components and elements The elements that are the same from figure to figure are designated with the same reference numerals.

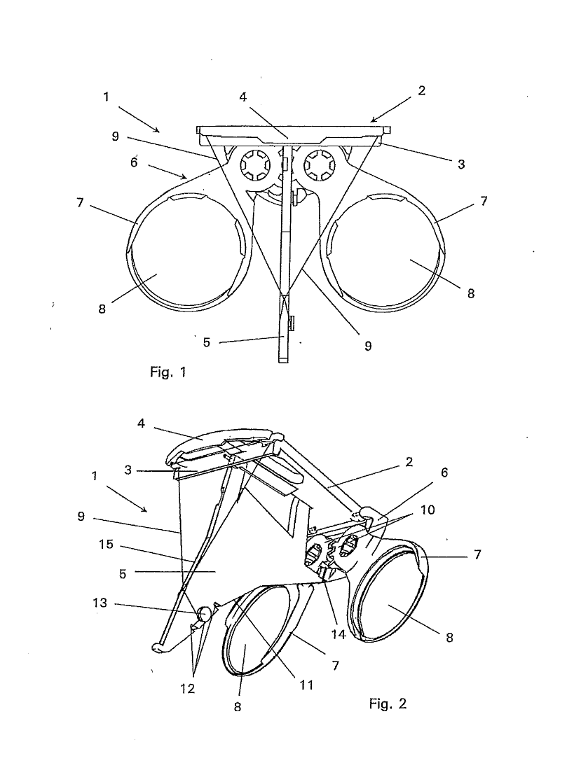

A first exemplary embodiment of a smartphone stereoscope of the invention is depicted and generally designated with the reference numeral 1 in FIGS. 1 through 7. The smartphone stereoscope 1 has a base 2, on which a support bar 3 is formed. This support bar 3 serves as a support for a longitudinal edge of a smartphone intended to be secured to the smartphone stereoscope 1 In particular it can be integrally formed with the base 2, which in particular is made of a plastic material. A bridge 4 that also serves as a support for a longitudinal edge of a smartphone is formed parallel to the support bar 3 and likewise integrally with the base.

In the unfolded state of the smartphone stereoscope 1 depicted in FIG. 1, a partition 5 is in an essentially 90 degree orientation to the plate-like base 2 and to the longitudinal direction of the support bar 3. The partition 5 is pivotally mounted on the base 2 and can be pivoted about a pivot axis that runs in the plane of the base 2 and essentially perpendicular to the longitudinal direction of the support bar 3 so that in the folded state, the plane of the plate-like partition 5 coincides with the plane of the base 2. This will be described in more detail further below.

A lens holder 6 is also pivotally mounted on the base 2. This lens holder 6 is also essentially plate-like in configuration and, in the unfolded state shown in FIG. 1, is oriented with its extension plane running at a right angle to the extension plane of the base 2 as well as to the extension plane of the partition 5. Accordingly, the respective planar orientations of the three plate-like elements base 2, partition 5, and lens holder 6 run in three linearly independent, mutually perpendicular spatial directions.

In the design shown, two lens receptacles 7 are arranged on the lens holder 6 in such a way that they can pivot relative to the latter for adjustment to the eye separation distance of a user. However, the lens receptacles 7 can just as easily be rigidly fixed, in particular also integrally formed, on the lens holder 6 with no possibility of adjusting their distance. A magnifying lens 8 is mounted in each lens receptacle 7. As FIG. 1 clearly shows, in their portions depicted in the figure in the lower area in each case, the lens receptacles 7 are open, encompass the circumference of a circular lens receptacle opening with channel-like holders having only partially circular segments with an aperture angle somewhat greater than 180° in each case, here ca. 190°. The magnifying lenses 8 may thus be easily introduced and mounted in the lens receptacles 7, specifically by inserting them from the open side until they lock or click into place in the lens receptacles 7. Like the other elements of the smartphone stereoscope 1, the lens receptacles 7 are also preferably made of a plastic material. In particular, the magnifying lenses 8 are likewise made of plastic and preferably implemented as Fresnel lenses.

Starting from lateral portions of the retaining bar 3, a rubber strap 9 extends triangularly toward the end of the partition 5 opposite the support bar 3 in the unfolded state according to FIG. 1, where the rubber strap 9 comes together and is secured. This rubber strap 9 serves to hold a smartphone, which is intended to abut the support bar 3 and a front edge 15 of the partition 5.

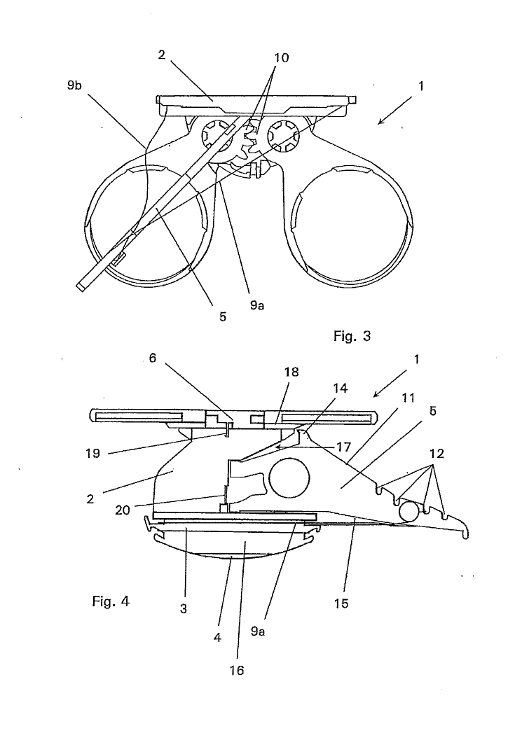

As can be discerned in, for example, FIGS. 2 and 3, the lens receptacles 7 have meshing teeth 10 in the portions by which they are pivotally connected to the lens holder 6. In this manner the pivot position of the lens receptacles 7, and hence the distance of the magnifying lenses 8 to each other, can be adjusted by moving one of the lens receptacles 7, wherein the other lens receptacle 7 follows the adjustment in corresponding mirror-inverted fashion owing to the gear coupling thus formed.

A rear edge 11 of the partition 5 is formed with a diagonal cutout, which during use serves as an opening through which the bridge of a user's nose protrudes between the lens receptacles 7.

On the end of the partition 5 opposite the support bar 3 in the unfolded position, notches 12 can be discerned on the rear edge 11. These notches 12 are for the variable fixing of the portion of the rubber strap 9 arranged thereon, which forms the vertex of the triangle depicted in FIG. 1 described by the rubber strap 9. A means of adjusting the size for accommodating smartphones of different dimensions is thus provided. This will become clearer in the following explanations. For additionally securing the rubber strap 9, the latter is connected to a pushbutton 13, which can also be fixed in the area of the notches 12. This pushbutton 13 serves as an additional anti-drop device and prevents a smartphone inserted behind the rubber strap 9 from slipping out of the holder and falling in the event that the rubber strap 9 accidentally detaches from the partition 5. It can also be discerned here that a portion 14 of the partition 5 bears on the lens holder 6 in order to stabilize the shape thus assumed in the unfolded state This portion actually interlocks with the lens holder 6, as will be described further below, and thus forms a solid and secure connection such that the smartphone stereoscope 1 is fixed and stable in this position.

The unique feature of the smartphone stereoscope 1 of the invention is the simple construction, which is stable in the unfolded state shown in FIGS. 1 and 2 and is the reason why the smartphone stereoscope 1 of the invention can be very easily collapsed to a compact size. This is shown in FIGS. 3 through 5. In a view comparable to that of FIG. 1, FIG. 3 shows an intermediate state, for example during the collapsing of the smartphone stereoscope 1. As shown therein, the partition 5 can be pivoted and folded down in relation to the base 2. As can be discerned in FIG. 3, in this process the portion 9a of the rubber strap is stretched and tensioned. The portion 9b of the rubber strap on the other hand becomes slack. The portion 9a of the rubber strap thus forms a reset means that forces the partition 5 into the position shown in FIG. 1, in the unfolded state of the smartphone stereoscope 1.

FIG. 4 shows a state in which the partition 5 is fully folded down. Again the portion 9a of the rubber strap can be discerned, which in this position is stretched tight and thus forces the partition 5 into the position assumed in the unfolded state according to FIG. 1. In FIG. 4 it is furthermore possible to discern the portion 14 of the partition 15 [sic] again, which in the unfolded state bears on and interlocks with and is thus releasably connected to the lens holder 6. Also discernible is a backdrop 18, which is formed on the lens holder 6 and via which the portion 14 is guided into a locking position.

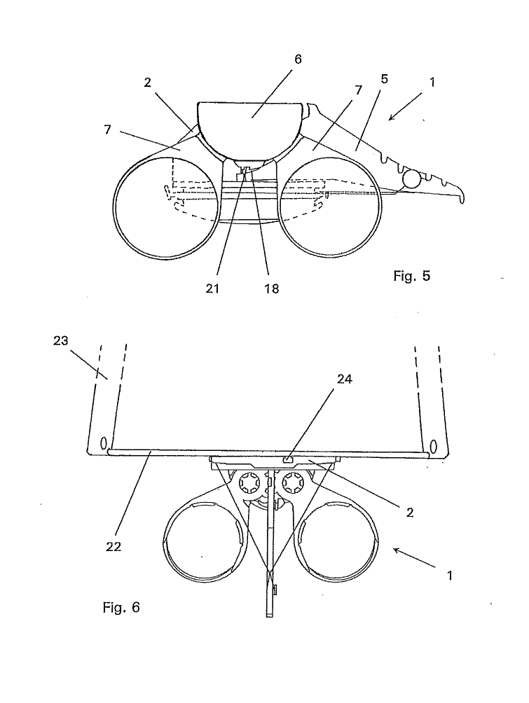

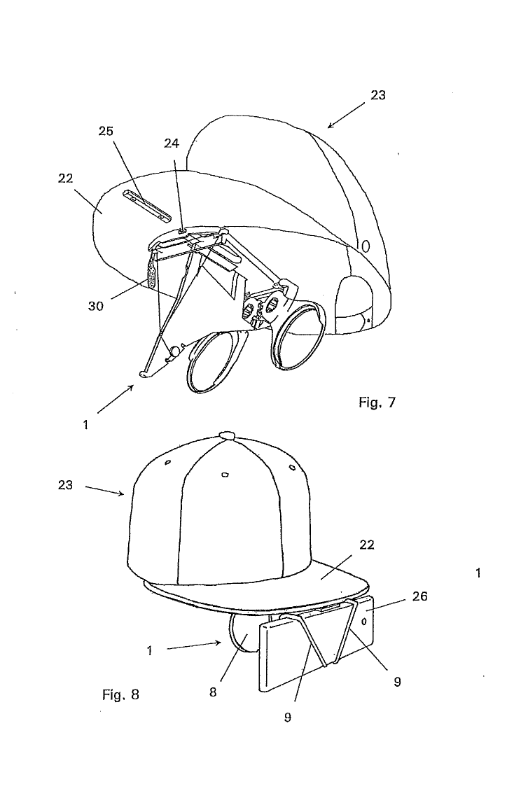

In FIG. 6 it can furthermore be discerned how the support bar 3 and the bridge 4 run parallel to one another and between them form a channel 16, into which a side edge of a smartphone can be inserted. The smartphone, which is pressed into the channel 16 by the rubber strap 9, is securely held in position by the support bar 3 and the bridge 4.

Lastly, a latching hook 19 formed on the lens holder 6 can be discerned. Even when the lens holder 6 is pivoted and folded onto the base 2 for collapsing, this latching hook engages behind a latching edge 20 and thus holds not only the lens holder 6 but also the partition 5 in the position assumed in the collapsed state of the smartphone stereoscope 1. This position or rather the folded state is then depicted in FIG. 5. In this position, the plate-like elements base 2, partition 5, and lens holder 6 with the lens receptacles 7 and the magnifying lenses 8 arranged thereon lie in a plane or in planes parallel to one another and stacked upon one another, thus giving rise to a flat and compact form that enables the smartphone stereoscope 1 to be carried easily and conveniently in, for example, a pocket or handbag.

The backdrop 18, which is formed on the lens holder 6, is again discernible in FIG. 5. An indexing notch 21 can furthermore be discerned thereon, in which the portion 14 of the partition 5 with the hook-like extension formed thereon engages when the lens holder 6 and the partition 5 are each brought into their positions assumed in the unfolded position of the smartphone telescope [sic] 1. This indexing notch 21 thus serves to lock the smartphone stereoscope 1 in the fully unfolded state.

Like the other designs in the illustrations that will be described in the following, the smartphone stereoscope 1 can in principle be used alone and as a hand-held device. But it is also particularly suited for connection to a baseball cap or visor cap in order to give rise to a head mounted display. In the following description and in the figures, reference is always made to a baseball cap. However, use can just as easily be made of a visor cap or other headgear with a visor (another style of peaked cap). The term “baseball cap” as used here should therefore include all comparable styles of peaked caps and headgear with visors.

FIG. 6 shows how the smartphone stereoscope 1 according to the preceding illustrations is arranged on the underside of a visor 23 [sic] of a baseball cap 23. To this end, the base 2 of the smartphone stereoscope 1 has a T-slot 24 on a top side. As can be discerned in FIG. 7, this T-slot 24 is guided over a T-track 25 and set thereon, the T-track 25 being fastened, for example screwed, onto the underside of the visor 22 of the baseball cap 23. With this constructive design, the smartphone stereoscope 1 can be releasably mounted in an expedient manner on the underside of the visor 22 of the baseball cap 23. By sliding it longitudinally along the T-track 25, the smartphone stereoscope 1 can be displaced in terms of a position on the underside of the visor 22 of the baseball cap 23, which is equivalent to being able to adjust the distance of the magnifying lenses 8 from the eyes of a user who is using the baseball cap 23 with the smartphone stereoscope 1 arranged thereon. This can be advantageous for persons who wear eyeglasses, for example, who need the magnifying lenses to be at an appropriate distance from their eyes so that they can also use the corrective eyeglasses while they are using the smartphone stereoscope 1, in other words so that the corrective eyeglasses will still fit between the eyes and the magnifying lenses 8 of the smartphone stereoscope 1.

Also discernible in FIG. 7 is a terry cloth band 30 applied to a headband of the baseball cap 23, which can absorb sweat and other moisture and which in particular also improves the wearing comfort of the baseball cap 23, specifically when the smartphone stereoscope 1 and a smartphone mounted thereon are fastened to the visor 22 of said baseball cap and exert pressure on the headband of the baseball cap with the force of their weight.

FIG. 8 schematically depicts how the smartphone stereoscope 1 is used in conjunction with the baseball cap 23 for viewing stereoscopic images that are reproduced on the display of a smartphone 26. It is shown here how the smartphone 26 is secured on the smartphone stereoscope 1 by means of the rubber straps 9. The smartphone stereoscope 1 bears with an upper longitudinal edge on the support bar 3 and is held by the bridge 4. By a lower longitudinal edge, it bears on the front edge 15 of the partition 5, in the area where the rubber strap 9 comes together. Due to the fact that the front edge 15 of the partition 5 is formed with a recess or kink oriented towards the rear edge 11 (as is particularly clear in FIG. 4), the smartphone 26 does bear fully with its delicate display side on the front edge 15, but only on two contact points on the upper and lower longitudinal edges in each case in the position shown in FIG. 8, regardless of the width of the smartphone. The smartphone 26 is positioned in front of or is arranged on the smartphone stereoscope 1 in a wide screen orientation

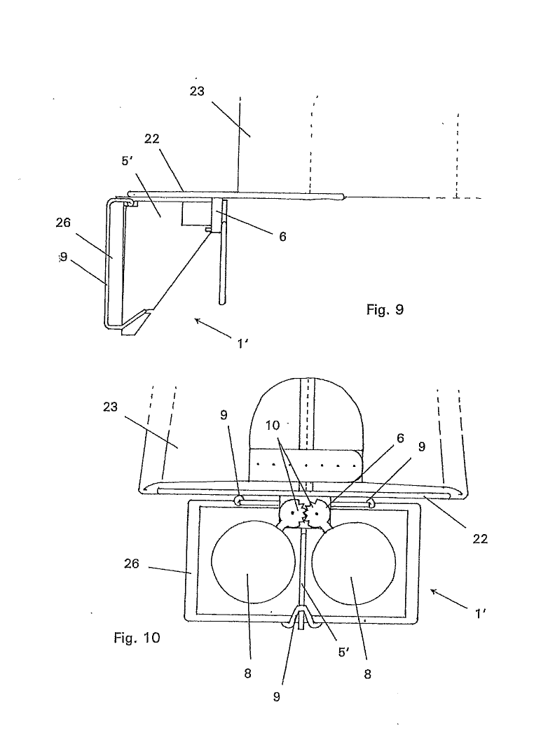

A side view of the situation shown in FIG. 8 is shown in FIG. 9, wherein a somewhat modified design of the smartphone stereoscope is depicted, which is designated with the reference numeral 1′. A somewhat differently designed partition 5′ can be discerned here, which is more simply shaped but functions in the same manner per se, is pivotal with respect to the base and is interlocked with the lens holder 6 in the unfolded state (cf. FIG. 9).

FIG. 10 shows the same arrangement in a frontal view, in other words from the side from which the viewer wearing the baseball cap 23 is looking at the arrangement. The magnifying lenses 8 are in front of the smartphone 26 accommodated in the smartphone stereoscope 1′, hence the viewer looks at the display of the smartphone 26 through the magnifying lenses 8. The partition 5′ is oriented parallel to the short edge side of the smartphone 26 and runs approximately in the center of the screen. The partition 5′ thus divides two individual images displayed on the left and the right of the screen, respectively, which together give rise to a stereoscopic image pair. Through the magnifying lenses 8, the viewer views the left image with the left eye and the right image with the right eye, wherein the images shown differ slightly in perspective and thus give rise to the three dimensional visual impression by being superimposed in the brain during viewing. The magnifying lenses 8 are chosen with respect to their focal lengths and their diameters so as to enable a view of the respective partial image of the screen (of the stereoscopic individual image) in which it is perceived in wide screen and magnified format. The focal lengths of the lenses can be in the range of 5-150 mm, particularly in the range of 40-60 mm. The diameters can be of the same order of magnitude; in particular use can be made of lenses with essentially identical focal lengths and diameters.

In FIG. 11 it can be discerned how the arrangement of the smartphone stereoscope 1′ on the visor 22 of the baseball cap 23 depicted in FIGS. 9 and 10 can be compactly folded together. In this state, the user of the baseball cap 23 is thus able to look past the form of the collapsed smartphone stereoscope 1′ thus minimized in terms of height and in particular held flat, for example when he is having a conversation with other people while still wearing the baseball cap 23.

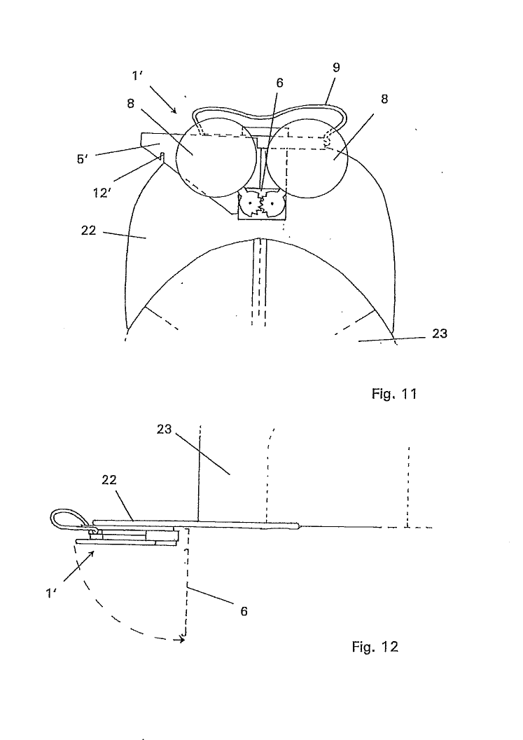

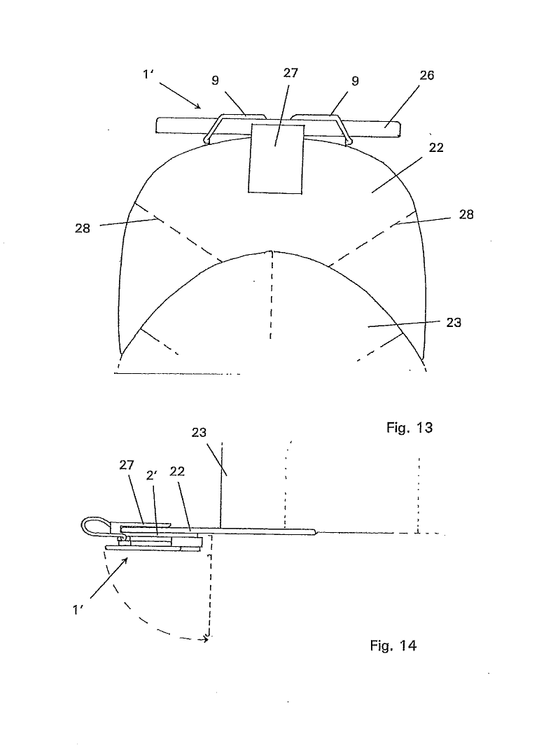

FIG. 12 shows a side view of the situation that is shown in a view from below in FIG. 11. In both figures it can be discerned that in this variant, the rubber strap 9 does not stay secured to the partition 5′ as said partition 5′ is folded over. Instead the rubber strap 9 is unhooked from a notch 12′, in which it would be hooked if a smartphone were to be attached to the smartphone stereoscope 1′. The curved arrow in FIG. 12 again shows how the lens holder 6 (indicated by dashed lines) is first pivoted outward by essentially 90° in order to move the smartphone stereoscope 1′ from the collapsed position into the unfolded position. The partition 5′ is then unfolded and interlocked with the lens holder 6, thus again producing the stable three dimensional structure.

Whereas FIG. 12 depicts a situation in which the smartphone stereoscope 1′ is in particular fixedly connected to the underside of the visor 23 [sic] of the baseball cap 23, FIGS. 13 and 14 show another variant. In this case the base 2′ is connected to a retaining clip 27, with which the smartphone stereoscope 1′ can be releasably fastened to the visor 22 of the baseball cap 23. This retaining clip 27 thus constitutes an alternative to the combination of a T-track 25 and a T-slot 24 in the exemplary embodiment described in the preceding for releasably fastening the smartphone stereoscope 1′ to the visor 22 of the baseball cap 23.

FIG. 13 also shows that the visor 22 can have crease lines 28 along which it can be folded over for compact storage of the baseball cap 23. These crease lines 28 run at an angle of ca. 20-60°, in particular 35°, to a forehead plane of a user who is wearing the baseball cap 23 with the visor in front and oriented forward. The arrangement according to FIG. 13 is shown again in FIG. 14, in a lateral view analogous to the depiction in FIG. 12.

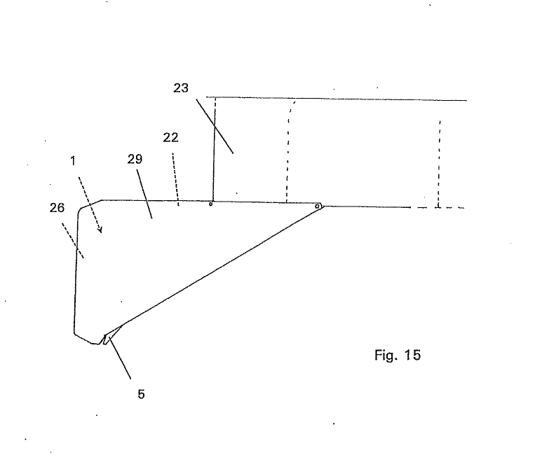

Lastly, FIG. 15 shows another possible design of the invention, in which the baseball cap 23 is combined with a flexible hood 29, which in particular can be elastic, for example like a bathing cap, wherein this hood 29 can in particular be guided and pulled over the visor 22 and the smartphone stereoscope 1 and a smartphone 26 accommodated therein. To this end, the hood can in particular be fastened, for example hooked, on the bottom end of the partition 5. In this manner the user obtains a darkened area for especially good viewing of stereoscopic images displayed on his smartphone 26, without scattered light and other interfering incident light. Privacy is also better protected.

Alternatively, the hood 29 can also be used in a position other than the one shown in FIG. 15. It can be pulled back over the head portion of the baseball cap 23 and thus likewise guided over the viewer's head. An additional retaining force that secures the baseball cap 23 on the user's head is exerted by the elasticity of the hood 29, which in particular relieves and more effectively counteracts the weight force, and consequently the tilting moment, exerted on the baseball cap 23 by the smartphone stereoscope 1 and especially by the smartphone 26 accommodated therein.

The preceding description of exemplary embodiments is purely an illustrative one, wherein individual features of the exemplary embodiments can also be combined with one another, as persons skilled in the art would obviously do. Other design variants not described here likewise fall within the general breadth and scope of the invention, as it is described in the following claims.

### List of Reference Numerals

1, 1′ Smartphone stereoscope

2, 2′ Base

3 Support bar

4 Bridge

5, 5′ Partition

6 Lens holder

7 Lens receptacle

8 Magnifying lens

9 Rubber strap

9a Portion

9b Portion

10 (Meshing) Teeth

11 Rear edge

12, 12′ Notch

13 Pushbutton

14 Portion

15 Front edge

16 Channel

17 Cutout

18 Backdrop

19 Latching hook

20 Latching edge

21 Indexing notch

22 Visor

23 Baseball cap

24 T-slot

25 T-track

26 Smartphone

27 Retaining clip

28 Crease line

29 Hood

30 Terry cloth band

1. A smartphone stereoscope comprising:
a receptacle adapted to releasably accommodate and secure at least one smartphone in a wide screen position;
a pair of magnifying lenses;
a partition, which, with the smartphone accommodated in the receptacle, extends in a direction parallel to a narrow longitudinal side of the at least one smartphone and lies in alignment with a dividing line between two images arranged side by side on a screen of the at least one smartphone for stereoscopic viewing,
a base; wherein the partition is arranged on the base so that the partition is pivotable between an unfolded position which the partition assumes in a use position of the smartphone stereoscope, and a collapsed position in which the partition lies parallel to the base or in a plane thereof;
a lens holder arranged on the base, wherein the lens holder has lens receptacles for accommodating the pair of magnifying lenses;
a support bar adapted to support a longitudinal edge of the at least one smartphone; wherein said support bar extending crosswise to the partition in the use position is provided on a first, top end of the partition;
a clamping and holding means provided for clamping and holding the at least one smartphone supported with a longitudinal edge on the support bar; wherein the smartphone stereoscope is collapsible in such a way that the partition, the base, the support bar, and the lens holder lie parallel to one another in a plane or in superimposed planes.

2. The smartphone stereoscope according to claim 1, wherein the base has the support bar integrally formed on a first side situated in a front during use; wherein the partition is mounted on the base so that the partition is pivotable about an axis that is perpendicular to a longitudinal direction of the support bar; wherein the lens holder with the magnifying lenses arranged thereon is arranged on the base so that the lens holder is pivotable about an axis that extends parallel to the longitudinal direction of the support bar.

3. The smartphone stereoscope according to claim 2, further comprising a cutout (17) in the base for accommodating a portion of the partition when the partition is pivoted out of the use position for collapsing.

4. The smartphone stereoscope according to claim 2 or further comprising a portion of the partition, which comes into engagement with a portion of the lens holder when the lens holder and the partition are pivoted into their positions assumed in the use position.

5. The smartphone stereoscope according to claim 4, further comprising a latching means on the portion of the partition and on the portion of the lens holder, which come into mutual engagement in the use position and interlock the lens holder and the partition in a latching manner.

6. The smartphone stereoscope according to claim 1, wherein the partition has a diagonally running edge line on a side oriented towards the lens holder in the use position, wherein as a result of the diagonally running edge line the partition tapers in depth from the top end to a bottom end.

7. The smartphone stereoscope according to claim 1, further comprising a bridge arranged on a side of the support bar oriented away from the lens holder and running parallel to the support bar, at a distance therefrom, in the use position.

8. The smartphone stereoscope according to claim 1, wherein the clamping and holding means is configured as an elastic pull strap which extends from two fastening points spaced apart from each other in a longitudinal direction of the support bar in a zone of the support bar to a common fastening point on the partition.

9. The smartphone stereoscope according to claim 8, wherein the common fastening point of the elastic pull strap, seen in a longitudinal direction extending from the top end to a bottom end of the partition is securable on the partition at different selectable longitudinal positions.

10. The smartphone stereoscope according to claim 8, wherein the elastic pull strap is arranged in such a way that as the partition is pivoted into the collapsed position, the elastic pull strap exerts a reset force thereon that forces the partition back into the unfolded position.

11. The smartphone stereoscope according to claim 1, wherein the clamping and holding means is formed by a partition that is spring-elastically tensioned in a compressed position and is capable of telescoping between the compressed position and an extended position.

12. The smartphone stereoscope according to claim 1, wherein the magnifying lenses are adjustable with respect to their distance from each other in the lens holder.

13. The smartphone stereoscope according to claim 12, wherein the lens receptacles are coupled with each other by means of a gear pair with meshing teeth and fix-mounted on the lens holder such that the lens receptacles pivot simultaneously and symmetrically as the distance between the lens receptacles is adjusted.

14. The smartphone stereoscope according to claim 1, wherein the magnifying lenses are Fresnel lenses.

15. The smartphone stereoscope according to claim 1, further comprising means for releasably securing the smartphone stereoscope on an underside of a visor of a baseball cap, of a visor cap, or of a comparable peaked cap.

16. The smartphone stereoscope according to claim 15, wherein the means of releasably securing the smartphone stereoscope on the underside of the visor of the baseball cap, the visor cap or the comparable peaked cap comprises an undercut slot which is formed in a top side of the base oriented away from the partition in the use position.

17. A baseball cap or visor cap or comparable peaked cap with a visor and a smartphone stereoscope according to claim 1, wherein the smartphone stereoscope is secured on an underside of the visor.

18. The baseball cap or visor cap or comparable peaked cap according to claim 17, further comprising a hood secured on the cap which is guidable over the visor and over the smartphone stereoscope and which is selectively releasably fastenable on a bottom end of the partition of the smartphone stereoscope.

19. The baseball cap (23) or visor cap or comparable peaked cap according to claim 18, wherein the hood is an elastic hood and is fastened on the cap in such a way that the elastic hood is selectively guidable over the visor and over the smartphone stereoscope and is selectively releasably securable on the bottom end of the partition of the smartphone stereoscope or guided over a top of a user's head in such a way that the elastic hood covers the top of the user's head.

20. The baseball cap or visor cap or comparable peaked cap according to claim 17, wherein the smartphone stereoscope is displaceable on the underside of the visor between different positions of distance from a user's face.

21. The baseball cap or visor cap or comparable peaked cap according to claim 17, further comprising an inner terry cloth covering on a headband portion of the cap.

22. The baseball cap or visor cap or comparable peaked cap according to claim 17, wherein two lateral tips of the visor oriented at an angle of from about 20° up to about 60° to a user's forehead are cut to an uppermost layer so that they are foldable through 180° onto a top part of a front visor part.

23. The smartphone stereoscope according to claim 1, wherein the support bar is oriented essentially perpendicular to the partition in the use position.

24. The baseball cap according to claim 22, wherein the two lateral tips of the visor are oriented at an angle of about 35° to the user's forehead.
